(19) United States
(12) Patent Application Publication
(10) Pub. No.: US 2004/0145543 A1
(43) Pub. Date: Jul. 29, 2004

(54) Display driving unit for method of displaying pixels and image display apparatus comprising such a display driving unit

(76) Inventors: Roel Van Woudenberg, Eindhoven (NL); Jurgen Jean Louis Hoppenbrouwers, Eindhoven (NL)

Correspondence Address: U S Philips Corporation, Intellectual Property Department, PO Box 3001, Briarcliff Manor, NY, 10510, US

(21) Appl. No.: 10/478,740

(22) PCT Filed: May 27, 2002
(86) PCT No.: PCT/IB02/01925

(30) Foreign Application Priority Data
May 29, 2001 (EP) 01202032.7

(51) Int. Cl. G09G 3/28

(52) U.S. Cl. 345/63

(57) ABSTRACT

A display driving method of displaying pixels of an image in a plurality of consecutive sub-fields (SF1-SF8) on a display panel (606) which is capable of generating in each of the sub-fields (SF1-SF8) a respective illumination level comprises two or more sequences of sub-fields (206,208). Each sequence of sub-fields (206,208) is preceded by one prime period (202,204) to setup the cells of the display panel. Each sub-field (e.g. SF1) comprises a selective-erase discharge period (108) and a sustain period (110). The various sub-fields (SF1-SF8) are assigned to the sequences of sub-fields (206,208).

The invention relates to a display driving method of displaying pixels of an image in a plurality of consecutive sub-fields on a display panel which is capable of generating in each of the sub-fields a respective illumination level, the display driving method comprising:

a first setup step to prime multiple cells of the display panel; and

a first address step to perform a first selective-erase discharge for a particular cell.

The invention further relates to display driving unit of displaying pixels of an image in a plurality of consecutive sub-fields on a display panel which is capable of generating in each of the sub-fields a respective illumination level, the display driving unit designed to generate:

a first setup pulse to prime multiple cells of the display panel; and

a first address pulse to perform a first selective-erase discharge for a particular cell.

The invention further relates to an image display apparatus for displaying an image, comprising:

receiving means for receiving a signal representing the image;

a display driving unit of displaying pixels of the image in a plurality of consecutive sub-fields on a display panel which is capable of generating in each of the sub-fields a respective illumination level, the display driving unit designed to generate:

a first setup pulse to prime multiple cells of the display panel; and

a first address pulse to perform a first selective-erase discharge for a particular cell; and

a display panel for displaying the image.

A method of the kind described in the opening paragraph is known from the article “Development of New Driving Method for AC-PDPs: High-Contrast, Low Energy Address and Reduction of False Contour Sequence CLEAR”, by T. Tokunaga et. al., in proceedings of IDW 1999, pages 787-790. In this article a novel method is disclosed of driving a plasma panel. The main advantage of this panel is the fast addressing time to switch off cells. A plasma display panel is driven in a plurality of sub-fields. A plasma display panel is made up of a number of cells that can be switched on and switched off. A cell corresponds with a pixel of the image that is to be displayed on the panel. In the operation of the plasma display panel driven by the above mentioned method, three types of periods can be distinguished. The first period is the setup period in which the cells of the panel are setup by setting appropriate voltages on their electrodes. A prime pulse is generated to achieve this result. In principle all cells are ready now to emit light. A period of the second type is an addressing period, in which the cells of the panel that are to be switched off are conditioned. Cells that are not addressed will emit light in the next period. Cells that are addressed will not, or no longer generate light in the field of the image. A selective erase pulse is generated to achieve this. A period of the third type is a sustain period, in which sustain pulses are applied to the cells which cause the non-addressed cells to emit light for the duration of the sustain period. The plasma display panel emits light during a sustain period. The addressing and sustain period together are called a sub-field period or simply a sub-field. A single image is displayed on the panel in a number of successive sub-fields. A cell may be switched on for one or more of the sub-fields. The light emitted by a cell in the sub-fields in which it was switched on, is integrated in the eye of the viewer who perceives a corresponding intensity for that cell. In a particular sub-field, the sustain period is maintained for a particular time resulting in a particular illumination level of the activated cells. Typically, different sub-fields have a different duration of their sustain phase. A sub-field is given a coefficient of weight, i.e. a sub-field weight, to express its contribution to the light emitted by the panel during the whole field period. By choosing appropriate sub-field weights a linear perceptive gray-scale transfer function can be realized. In the article “Development of New Driving Method for AC-PDPs: High-Contrast, Low Energy Address and Reduction of False Contour Sequence CLEAR”, an incremental sub-field scheme is described. This means that the sub-field weight of a sub-field is higher than or equal to the sub-field weight of its predecessor, if any. The sub-field scheme as described is also accumulative. Cells are switched on between the prime and the selective-erase discharge. By selecting the number of sub-fields in which a cell is switched on, 13 different intensity levels can be realized in displaying an image on a panel which comprises 12 sub-fields. This relatively low number of intensity levels is a major disadvantage of the plasma display panel driven by the method described above. In the article it is described that with error diffusion and dithering the gray scale transfer function can be smoothed. However this only masks the fact that the number of actual intensity levels, i.e. gray-levels is relatively low.

It is a first object of the invention to provide a display driving method of the kind described in the opening paragraph resulting in a relatively high number of intensity levels generated by the display device.

It is a second object of the invention to provide a display driving unit of the kind described in the opening paragraph with a relatively high number of intensity levels generated by the display device.

It is a third object of the invention to provide an image display apparatus comprising a display driving unit of the kind described in the opening paragraph with a relatively high number of intensity levels generated by the display device.

The first object of the invention is achieved in that the display driving method further comprises:

a second setup step to prime the multiple cells of the display panel; and

a second address step to perform a second selective-erase discharge for the particular cell,

resulting in a first sequence of sub-fields and a second sequence of sub-fields, in which the particular cell can emit light. In a display panel controlled according to the method of the prior art a cell may be switched on for one or more of the sub-fields. However, when a cell is switched off the cell can not be switched on again for an image. This means that for each cell there is one sequence of sub-fields in which the particular cell can emit light. The order of sub-fields is fixed. Hence, the number of different intensity levels that can be realized is fully determined by the number of sub-fields in which a cell is switched on. By creating more than one sequence of sub-fields, in which the particular cell can emit light, it is achieved that there is more freedom in selecting combinations of sub-fields. If the number of sub-fields is N=12 then the number of distinct intensity levels increases to (N/2+1)*(N/2+1)−1=48 if two sequences of sub-fields, in which the particular cell can emit light, are generated and if there are no redundant combinations. Generation of more than two sequences of sub-fields, in which the particular cell can emit light, is possible. In that case additional prime and selective-erase discharges are required for the various cells.

An embodiment of the display driving method according to the invention distributes the consecutive sub-fields of the image substantially evenly over the first sequence of sub-fields and the second sequence of sub-fields. It is preferred that the number of sub-fields of the first and the second sequence of sub-fields are mutually equal. The difference between the sum of sub-field weights of the sub-fields of the first sequence of sub-fields and the sum of sub-field weights of the second sequence of sub-fields is preferably relatively small. The result is that the difference in the amount of light emitted during the first sequence of sub-fields and the amount of light emitted during the second sequence of sub-fields is relatively small. The result is that there are two peaks in the amount of light, emitted by the display panel, as function of time. The effect is that large area flicker, i.e. at the image refresh frequency, is reduced. This is e.g. 50 Hz for PAL.

An embodiment of the display driving method according to the invention assigns the consecutive sub-fields of the image alternatively to the first sequence of sub-fields and the second sequence of sub-fields. With this assignment scheme the difference in the amount of light emitted during the first sequence of sub-fields and the amount of light emitted during the second sequence of sub-fields can be kept relatively small.

In an embodiment of the display driving method according to the invention, a difference between a first number of sub-fields assigned to the first sequence of sub-fields, in which the particular cell emits light and a second number of sub-fields assigned to the second sequence of sub-fields, in which the particular cell emits light is relatively small. Besides the assignment of sub-fields to the sequences of sub-fields it is also important to determine which combinations of sequences to apply. To achieve the required illumination level of the particular pixel the corresponding cell must be switched on during one or more of the sub-fields. In principle it is possible that the cell only emits light during one or more of the sub-fields of the first sequence of sub-fields and no light during the second sequence of sub-fields. However to prevent large area flicker it is favorable that the difference between the first number of sub-fields assigned to the first sequence of sub-fields, in which the particular cell emits light and the second number of sub-fields assigned to the second sequence of sub-fields, in which the particular cell emits light is small. A maximum difference of one or two sub-fields is preferred in the case of 12 sub-fields. In the case of e.g. 20 sub-fields a higher difference is allowed.

The second object of the invention is achieved in that the display driving unit is designed to generate:

a second setup pulse to prime the multiple cells of the display panel; and

a second address pulse to perform a second selective-erase discharge for the particular cell, resulting in a first sequence of sub-fields and a second sequence of sub-fields.

The third object of the invention is achieved in that the display driving unit is designed to generate:

a second setup pulse to prime the multiple cells of the display panel; and

a second address pulse to perform a second selective-erase discharge for the particular cell, resulting in a first sequence of sub-fields and a second sequence of sub-fields.

These and other aspects of the display driving unit for and the display driving method of displaying pixels and the image display apparatus according to the invention will become apparent from and will be elucidated with reference with respect to the implementations and embodiments described hereinafter and with reference to the accompanying drawings, wherein:

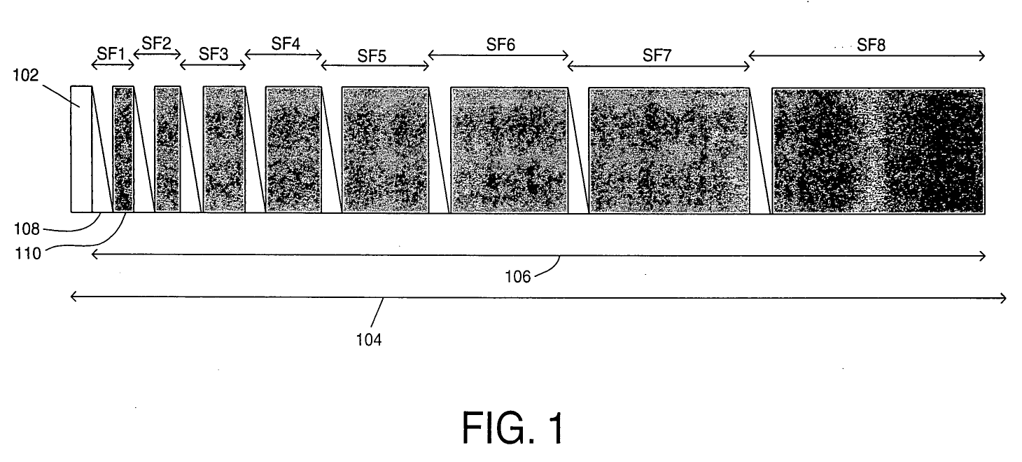

FIG. 1 schematically shows a field period with 8 sub-fields, according to the prior art;

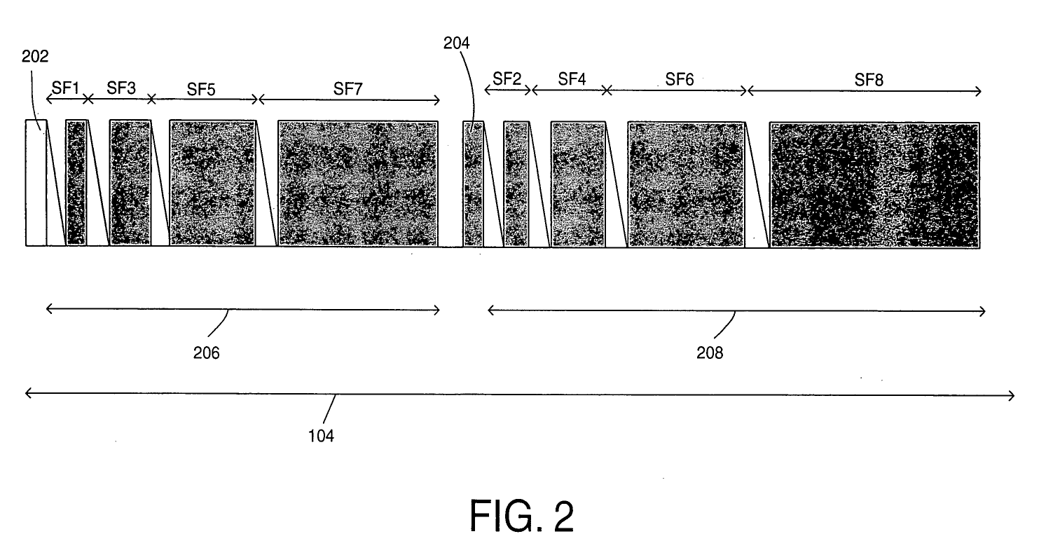

FIG. 2 schematically shows a field period with two sequences of 4 sub-fields each, according to the invention;

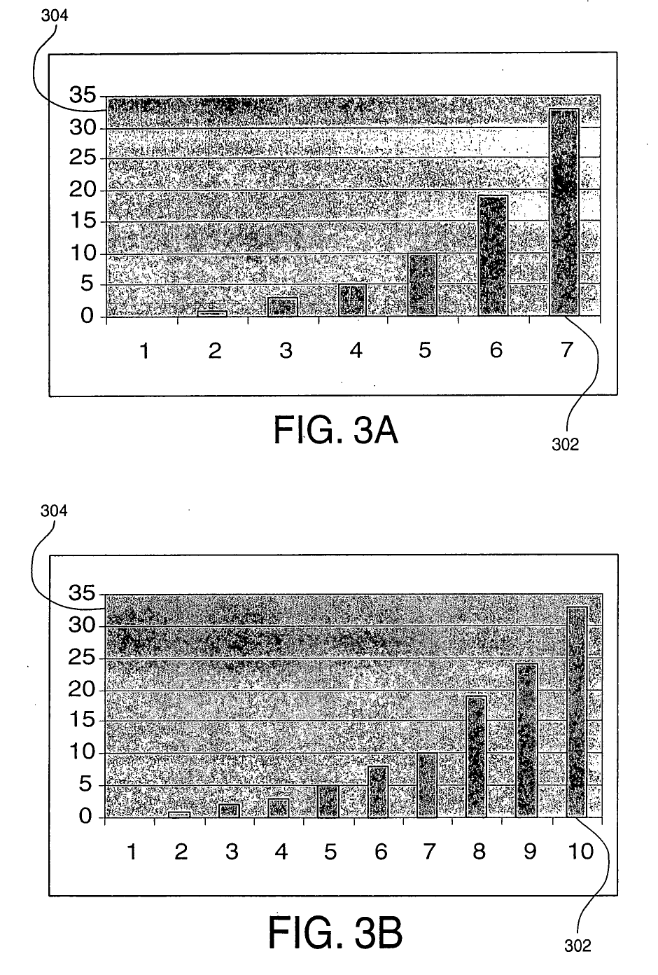

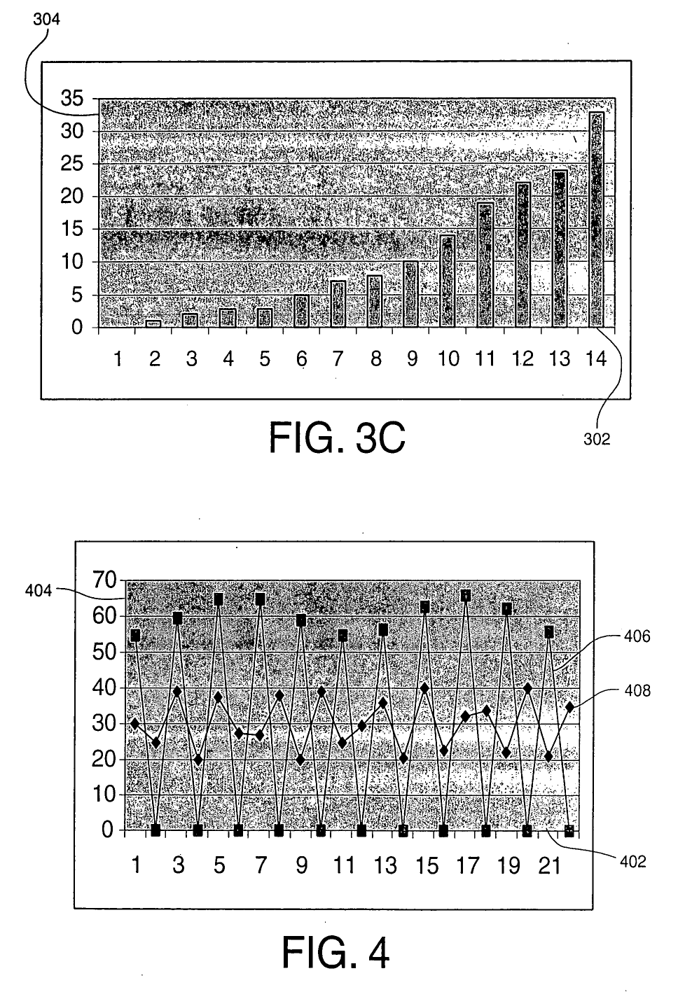

FIG. 3A schematically shows a gray-scale transfer function with 7 distinct levels;

FIG. 3B schematically shows a gray-scale transfer function with 10 distinct levels;

FIG. 3C schematically shows a gray-scale transfer function with 14 distinct levels;

FIG. 4 schematically shows two signals related to the amount of light emitted by a display panel as function of time.

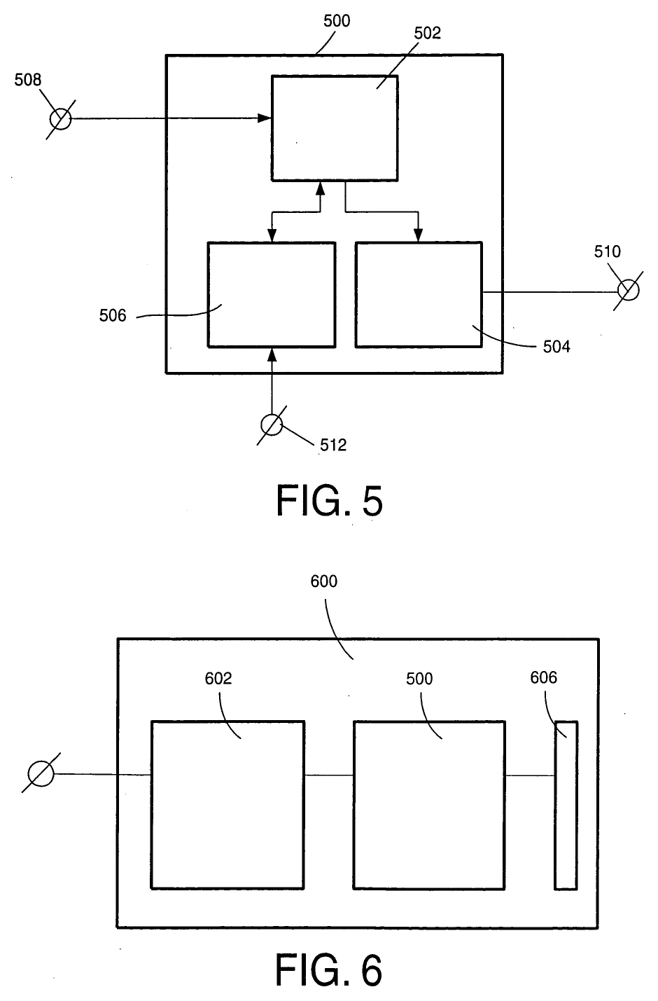

FIG. 5 schematically shows a display driving unit; and

FIG. 6 shows elements of an image display apparatus.

FIG. 1 schematically shows a field period 104 with 8 sub-fields SF1-SF8. A plasma display panel is driven in a plurality of sub-fields SF1-SF8. A plasma display panel is made up of a number of cells that can be switched on and switched off. A cell corresponds with a pixel of the image that is to be displayed on the panel. In the operation of the plasma display panel driven by the method according to the prior art, three types of periods can be distinguished. The first period is the setup period 102 in which the cells of the panel are setup by setting appropriate voltages on their electrodes. A prime pulse is generated to achieve this result. In principle all cells are ready now to emit light. A period of the second type, e.g. 108, is an addressing period, in which the cells of the panel that are to be switched off are conditioned. Cells that are not addressed will emit light in the next period. Cells that are addressed will not, or no longer generate light in the field of the image. A selective erase pulse is generated to achieve this. A period of the third type, e.g. 110, is a sustain period, in which sustain pulses are applied to the cells which cause the non-erased, i.e. non-addressed cells to emit light for the duration of the sustain period. The plasma display panel emits light during a sustain period, e.g. 110. The addressing 108 and sustain period 110 together are called a sub-field, e.g. SF1. A single image is displayed on the panel in a number of successive sub-fields SF1-SF8. A cell may be switched on for one or more of the sub-fields SF1-SF8. The light emitted by a cell in the sub-fields SF1-SF8 in which it was switched on, is integrated in the eye of the viewer who perceives a corresponding intensity for that cell. In a particular sub-field SF1, the sustain period is maintained for a particular time resulting in a particular illumination level of the activated cells. Typically, different sub-fields SF1-SF8 have a different duration of their sustain phase. A sub-field is given a coefficient of weight, i.e. a sub-field weight, to express its contribution to the light emitted by the panel during the whole field period 104. By choosing appropriate sub-fields weights a linear perceptive gray-scale transfer function can be realized. FIG. 1 is related to a plasma display panel with 8 sub-fields having coefficients of incremental weight: the sub-fields SF1-SF8 are incrementally ordered. The sub-field weight of a sub-field, e.g. SF2, is higher than, or equal to the sub-field weight of its predecessor SF1. By selecting the number of sub-fields in which a cell is switched on, 9 different intensity levels can be realized in displaying an image on this panel.

FIG. 2 schematically shows a field period with two sequences of 4 sub-fields each, in which cells can emit light. The fist sequence of sub-fields 206 comprises the sub-fields SF1, SF3, SF5 and SF7. The second sequence of sub-fields 208 comprises the sub-fields SF2, SF4, SF6 and SF8. The first sequence of sub-fields 206 is preceded by a setup period 202. The second sequence of sub-fields 208 is preceded by a setup period 204.

FIG. 3A schematically shows a gray-scale transfer function with 7 distinct gray levels. The x-axis 302 provides the identifications of the 7 distinct sub-field combinations which are possible with a driving method as explained in FIG. 1 in the case that there are 6 sub-fields. On the y-axis 304 the corresponding gray-levels are indicated. Table 1 includes similar information. The first row of table 1 indicates the order in time of the 6 sub-fields, i.e. SF1 is the first sub-field in the field after the prime, SF2 the second sub-field and SF6 the last sub-field. In the second row the sub-field weights, corresponding to the illumination levels are indicated. In the other rows it is indicated whether a particular cell emits light in the various sub-fields or not, by respectively a “1” or “0”. The column at the right hand-side indicates the resulting illumination level of the particular pixel, which is related to the total emitted light by the particular cell. It can be seen that 7 distinct gray-levels can be made with the 6 sub-fields.

TABLE 1

| | Sub-field | | | | | | |
|---|---|---|---|---|---|---|---|
| | SF1 | SF2 | SF3 | SF4 | SF5 | SF6 | |
| | Sub-field weight | | | | | | Illumination |
| | 1 | 2 | 2 | 5 | 9 | 14 | level |
| 1 | 0 | 0 | 0 | 0 | 0 | 0 | 0 |
| 2 | 1 | 0 | 0 | 0 | 0 | 0 | 1 |
| 3 | 1 | 1 | 0 | 0 | 0 | 0 | 3 |
| 4 | 1 | 1 | 1 | 0 | 0 | 0 | 5 |
| 5 | 1 | 1 | 1 | 1 | 0 | 0 | 10 |
| 6 | 1 | 1 | 1 | 1 | 1 | 0 | 19 |
| 7 | 1 | 1 | 1 | 1 | 1 | 1 | 33 |

One sequence of sub-fields

In table 2 the sub-field combinations are depicted in the case of an alternative sub-field order. The number of used sub-field combinations is equal to the number of table 1. The first row of table 2 indicates the order in time of the 6 sub-fields, i.e. SF1 is the first sub-field in time in the field after the prime, SF3 the second sub-field and SF6 the last sub-field. The conventions used in table 2 are the same as used in table 1. An advantage of this sub-field order is that the large area flicker is less compared to the sub-field order as indicated in table 1. See also FIG. 4. The gray-scale transfer functions for the sub-field order as described in table 1 and table 2 are mutual equal, see FIG. 3A. Two prime pulses per field are required to achieve this order of sub-fields.

TABLE 2

| | Sub-field | | | | | | |
|---|---|---|---|---|---|---|---|
| | SF1 | SF3 | SF5 | SF2 | SF4 | SF6 | |
| | Sub-field weight | | | | | | Illumination |
| | 1 | 2 | 9 | 2 | 5 | 14 | level |
| 1 | 0 | 0 | 0 | 0 | 0 | 0 | 0 |
| 2 | 1 | 0 | 0 | 0 | 0 | 0 | 1 |
| 3 | 1 | 0 | 0 | 1 | 0 | 0 | 3 |
| 4 | 1 | 1 | 0 | 1 | 0 | 0 | 5 |
| 5 | 1 | 1 | 0 | 1 | 1 | 0 | 10 |
| 6 | 1 | 1 | 1 | 1 | 1 | 0 | 19 |
| | 1 | 1 | 1 | 1 | 1 | 1 | 33 |

| | |
|---|---|
| First sequence | Second sequence |
| of sub-fields | of sub-fields |

In table 3 the sub-field combinations are depicted in the case of a second alternative sub-field order. The number of used sub-field combinations is equal to the number of table 1. See the description of tables 1 and 2 for further explanation. An advantage of this sub-field order is that the large area flicker is less compared to the sub-field order as indicated in table 1. Two prime pulses per field are required to achieve this order of sub-fields.

TABLE 3

| | Sub-field | | | | | | |
|---|---|---|---|---|---|---|---|
| | SF1 | SF4 | SF5 | SF2 | SF3 | SF6 | |
| | Sub-field weight | | | | | | Illumination |
| | 1 | 5 | 9 | 2 | 2 | 14 | level |
| 1 | 0 | 0 | 0 | 0 | 0 | 0 | 0 |
| 2 | 1 | 0 | 0 | 0 | 0 | 0 | 1 |
| 3 | 1 | 0 | 0 | 1 | 0 | 0 | 3 |
| 4 | 1 | 0 | 0 | 1 | 1 | 0 | 5 |
| 5 | 1 | 1 | 0 | 1 | 1 | 0 | 10 |
| 6 | 1 | 1 | 1 | 1 | 1 | 0 | 19 |
| 7 | 1 | 1 | 1 | 1 | 1 | 1 | 33 |

| | |
|---|---|
| First sequence of | Second sequence of |
| sub-fields | sub-fields |

FIG. 3B schematically shows a gray-scale transfer function with 10 distinct gray levels. The x-axis 302 provides the identifications of the 10 distinct sub-field combinations which are possible with a driving method as explained in FIG. 2 in the case that there are 6 sub-fields and under the restriction that the difference between a first number of sub-fields assigned to the first sequence of sub-fields, in which a particular cell emits light and a second number of sub-fields assigned to the second sequence of sub-fields, in which the particular cell emits light is less then two. On the y-axis 304 the corresponding gray-levels are indicated. Table 4 includes similar information. Two prime pulses per field are required to achieve the sub-field combinations. The first row of table 4 indicates the order in time of the 6 sub-fields. SF1 is the first sub-field in the field after the first prime, SF3 the second sub-field and SF 3 the last sub-field. SF2 is the first sub-field in the field after the second prime, SF4 the second sub-field and SF 6 the last sub-field. The conventions used in table 4 are the same as used in table 1. Alternative sub-field orders are possible, e.g. those as described in tables 1, 2 and 3.

TABLE 4

| | Sub-field | | | | | | |
|---|---|---|---|---|---|---|---|
| | SF1 | SF3 | SF5 | SF2 | SF4 | SF6 | |
| | Sub-field weight | | | | | | Illumination |
| | 1 | 2 | 9 | 2 | 5 | 14 | level |
| 1 | 0 | 0 | 0 | 0 | 0 | 0 | 0 |
| 2 | 1 | 0 | 0 | 0 | 0 | 0 | 1 |
| 3 | 0 | 0 | 0 | 1 | 0 | 0 | 2 |
| 4 | 1 | 0 | 0 | 1 | 0 | 0 | 3 |
| 5 | 1 | 1 | 0 | 1 | 0 | 0 | 5 |
| 6 | 1 | 0 | 0 | 1 | 1 | 0 | 8 |
| 7 | 1 | 1 | 0 | 1 | 1 | 0 | 10 |
| 8 | 1 | 1 | 1 | 1 | 1 | 0 | 19 |
| 9 | 1 | 1 | 0 | 1 | 1 | 1 | 24 |
| 10 | 1 | 1 | 1 | 1 | 1 | 1 | 33 |

| | |
|---|---|
| First sequence of | Second sequence of |
| sub-fields | sub-fields |

FIG. 3C schematically shows a gray-scale transfer function with 14 distinct gray levels. The x-axis 302 provides the identifications of the 14 distinct sub-field combinations which are possible with a driving method as explained in FIG. 2 in the case that there are 6 sub-fields and under the restriction that the difference between a first number of sub-fields assigned to the first sequence of sub-fields, in which a particular cell emits light and a second number of sub-fields assigned to the second sequence of sub-fields, in which the particular cell emits light is less then three. See also table 5.

TABLE 5

| | Sub-field | | | | | | |
|---|---|---|---|---|---|---|---|
| | SF1 | SF3 | SF5 | SF2 | SF4 | SF6 | |
| | Sub-field weight | | | | | | Illumination |
| | 1 | 2 | 9 | 2 | 5 | 14 | level |
| 1 | 0 | 0 | 0 | 0 | 0 | 0 | 0 |
| 2 | 1 | 0 | 0 | 0 | 0 | 0 | 1 |
| 3 | 0 | 0 | 0 | 1 | 0 | 0 | 2 |
| 4 | 1 | 0 | 0 | 1 | 0 | 0 | 3 |
| 5 | 1 | 1 | 0 | 0 | 0 | 0 | 3 |
| 6 | 1 | 1 | 0 | 1 | 0 | 0 | 5 |
| 7 | 0 | 0 | 0 | 1 | 1 | 0 | 7 |
| 8 | 1 | 0 | 0 | 1 | 1 | 0 | 8 |
| 9 | 1 | 1 | 0 | 1 | 1 | 0 | 10 |
| 10 | 1 | 1 | 1 | 1 | 0 | 0 | 14 |
| 11 | 1 | 1 | 1 | 1 | 1 | 0 | 19 |
| 12 | 1 | 0 | 0 | 1 | 1 | 1 | 22 |
| 13 | 1 | 1 | 0 | 1 | 1 | 1 | 24 |
| 14 | 1 | 1 | 1 | 1 | 1 | 1 | 33 |

| | |
|---|---|
| First sequence of | Second sequence of |
| sub-fields | sub-fields |

FIG. 4 schematically shows two signals 406,408 related to the amount of light emitted by a display panel as function of time. The x-axis 402 corresponds with time. The y-axis 404 indicates the amount of light which was emitted by a display panel during predetermined intervals of time. The integrals of both curves 406,408 are mutual equal: the average amount of light as function of time is mutual equal. The main difference between the signals 406,408 is that for signal 406 the modulation depth, i.e. amplitude is much higher then for signal 408. A high modulation depth might result in large area flicker. This depends on the frequency of the changes of the amount of light per time interval. A sub-field order as described in FIG. 1 might result in a signal 406. A sub-field order as described in FIG. 2 might result in a signal 408.

FIG. 5 schematically shows a display driving unit 500 comprising:

a controller 502 designed to receive the input signal and to control the operation of the display driving unit 500.

a pulse generator 504 for generating the appropriate pulses to drive the display panel, e.g. prime pulses and selective erase discharge pulses;

a memory device 506 for persistent storage of configuration data, e.g. possible sub-field sequences. The memory device 506 implements Look-Up-Tables comprising the mapping from pixel values to combinations of sub-fields. These type of mappings can be found in the tables 1-5.

A signal representing the pixel values of an image is provided to the input connector 508 of the display driving unit 500. The pulses to drive the display panel are provided at the output connector 510 of the display driving unit 500. Configuration data can be provided to the display driving unit 500 by means of the configuration input connector 512.

FIG. 6 shows elements of an image display apparatus according to the invention. The image display apparatus 600 has a receiving means 602 for receiving a signal representing the image to be displayed. The signal may be a broadcast signal received via an antenna or cable but may also be a signal from a storage device like a VCR (Video Cassette Recorder) or Digital Versatile Disk (DVD). The image display apparatus 600 further has a display driving unit 500 for controlling the display panel 606 which displays the image. The display driving unit 500 is described in FIG. 4. The display panel 606 is of a type that is driven in sub-fields.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A display driving method of displaying pixels of an image in a plurality of consecutive sub-fields (SF1-SF8) on a display panel (606) which is capable of generating in each of the sub-fields (SF1-SF8) a respective illumination level, the display driving method comprising:
a first setup step to prime multiple cells of the display panel (606); and
a first address step to perform a first selective-erase discharge for a particular cell,
characterized in that the display driving method further comprises:
a second setup step to prime the multiple cells of the display panel; and
a second address step to perform a second selective-erase discharge for the particular cell, resulting in a first sequence of sub-fields (206) and a second sequence of sub-fields (208), in which the particular cell can emit light.

2. A display driving method as claimed in claim 1, characterized in that the display driving method distributes the consecutive sub-fields (SF1-SF8) of the image substantially evenly over the first sequence of sub-fields (206) and the second sequence of sub-fields (208).

3. A display driving method as claimed in claim 2, characterized in that the display driving method assigns the consecutive sub-fields (SF1-SF8) of the image alternatively to the first sequence of sub-fields (206) and the second sequence of sub-fields (208).

4. A display driving method as claimed in claim 2, characterized in that a difference between a first number of sub-fields assigned to the first sequence of sub-fields (206), in which the particular cell emits light and a second number of sub-fields assigned to the second sequence of sub-fields (208), in which the particular cell emits light is relatively small.

5. A display driving unit (500) of displaying pixels of an image in a plurality of consecutive sub-fields (SF1-SF8) on a display panel (606) which is capable of generating in each of the sub-fields (SF1-SF8) a respective illumination level, the display driving unit (500) designed to generate:
a first setup pulse to prime multiple cells of the display panel; and
a first address pulse to perform a first selective-erase discharge for a particular cell,
characterized in that the display driving unit (500) is designed to generate:
a second setup pulse to prime the multiple cells of the display panel; and
a second address pulse to perform a second selective-erase discharge for the particular cell, resulting in a first sequence of sub-fields (206) and a second sequence of sub-fields (208), in which the particular cell can emit light.

6. A display driving unit (500) as claimed in claim 5, characterized in that the display driving unit (500) is designed to distribute the consecutive sub-fields (SF1-SF8) of the image substantially evenly over the first sequence of sub-fields (206) and the second sequence of sub-fields (208).

7. A display driving unit (500) as claimed in claim 5, characterized in that the display driving unit (500) is designed to assign the consecutive sub-fields (SF1-SF8) of the image alternatively to the first sequence of sub-fields (206) and the second sequence of sub-fields (208).

8. A display driving unit (500) as claimed in claim 5, characterized in that a difference between a first number of sub-fields assigned to the first sequence of sub-fields (206), in which the particular cell emits light and a second number of sub-fields assigned to the second sequence of sub-fields (208), in which the particular cell emits light is relatively small.

9. An image display apparatus (600) for displaying an image, comprising:
receiving means (602) for receiving a signal representing the image;
a display driving unit (500) of displaying pixels of the image in a plurality of consecutive sub-fields (SF1-SF8) on a display panel (606) which is capable of generating in each of the sub-fields (SF1-SF8) a respective illumination level, the display driving unit (500) designed to generate:
a first setup pulse to prime multiple cells of the display panel; and
a first address pulse to perform a first selective-erase discharge for a particular cell; and
a display panel (606) for displaying the image, characterized in that the display driving unit (500) is designed to generate:
a second setup pulse to prime the multiple cells of the display panel; and
a second address pulse to perform a second selective-erase discharge for the particular cell, resulting in a first sequence of sub-fields (206) and a second sequence of sub-fields (208), in which the particular cell can emit light.

10. An image display apparatus (600) as claimed in claim 9, characterized in that the display driving unit (500) is designed to distribute the consecutive sub-fields (SF1-SF8) of the image substantially evenly over the first sequence of sub-fields (206) and the second sequence of sub-fields (208).

11. An image display apparatus (600) as claimed in claim 9, characterized in that the display driving unit (500) is designed to assign the consecutive sub-fields (SF1-SF8) of the image alternatively to the first sequence of sub-fields (206) and the second sequence of sub-fields (208).

12. An image display apparatus (600) as claimed in claim 9, characterized in that a difference between a first number of sub-fields assigned to the first sequence of sub-fields (206), in which the particular cell emits light and a second number of sub-fields assigned to the second sequence of sub-fields (208), in which the particular cell emits light is relatively small.
